(19) United States
(12) Patent Application Publication
(10) Pub. No.: US 2012/0109779 A1
(43) Pub. Date: May 3, 2012

(54) METHOD AND SYSTEM FOR SHARING DIGITAL CONTENT

(75) Inventors: Ki-Eun SHIN, Bucheon-si (KR); Yong-Ho YOU, Seoul (KR)

(73) Assignee: Samsung Electronics Co, Ltd., Suwon-si (KR)

(21) Appl. No.: 13/275,799

(22) Filed: Oct. 18, 2011

(30) Foreign Application Priority Data
Nov. 2, 2010 (KR) 10-2010-0108047

(51) Int. Cl. G06Q 30/06

(52) U.S. Cl. 705/26.8

(57) ABSTRACT

A method and system for sharing digital content are provided. The method includes creating, by a first user, a purchase request message containing a content ID of digital content to be purchased, and transmitting the purchase request message to a content providing server, transmitting, by the content providing server, requested content to the first user, and transmitting content meta data containing a user ID of the first user and the content ID to an integrated management server, storing, the first user, the received content, and examining, by the integrated management server that manages content lists for individual users, the content meta data, adding the purchased content to an integrated content list of the first user, and displaying the integrated content list.

### PRIORITY

This application claims the benefit under 35 U.S.C. §119(a) of a Korean patent application filed on Nov. 2, 2010 in the Korean Intellectual Property Office and assigned Serial No. 10-2010-0108047, the entire disclosure of which is hereby incorporated by reference.

### BACKGROUND OF THE INVENTION

1. Field of the Invention

The present invention relates to management of digital content. More particularly, the present invention relates to a method and system that enable individual users to manage digital content in an integrated manner.

2. Description of the Related Art

Most sales systems for digital content, such as e-books, movies and songs, apply various Digital Rights Management (DRM) techniques to prevent copyright infringement such as unauthorized copying and sharing. Using DRM, publishers and authors are able to avoid a loss of revenue through unauthorized sales of their material, such as e-books. In the following description, it is assumed that digital content refers to an e-book. A person having bought a printed book, other than an e-book, may resell the book to another person or lend the book to another person for a fee (i.e., rent the e-book). However, an e-book sales system does not allow resale or lending of an e-book to prevent copying.

In recent years, the number of subscribers to Social Network Services (SNS) like Twitter has rapidly increased. Many persons use social network services to build personal relations and share interests. Currently, service providers combine social network services with other types of services such as location-based services and streaming services to provide users with rich experiences.

Current e-book sales systems tend to employ a mode of transaction based on purchasing agents like Amazon. A user may purchase a DRM-protected e-book. However, the purchased e-book is not truly in the possession of the user. In other words, the user having purchased an e-book may be unable to lend or resell the purchased e-book to another person.

Accordingly, there is a need for an apparatus and method for enabling a user to lend or resell purchased digital contents to another user.

### SUMMARY OF THE INVENTION

Aspects of the present invention are to address at least the above-mentioned problems and/or disadvantages and to provide at least the advantages described below. Accordingly, an aspect of the present invention is to provide a method and system that can promote the sale of Digital Rights Management (DRM)-protected digital content and enable a user to lend and/or resell purchased digital content to another user.

Another aspect of the present invention is provide a method and system that enable a user to manage various purchased digital content in an integrated manner and to store digital content produced by the user in a bookshelf.

Still another aspect of the present invention is to provide a method and system that enable sharing and rental (or resale) of digital content through social network services and building of user communities to increase user satisfaction.

In accordance with an aspect of the present invention, a method for sharing digital content is provided. The method includes creating, by a first user, a purchase request message containing a content ID of digital content to be purchased, and transmitting the purchase request message to a content providing server, transmitting, by the content providing server, requested content to the first user, and transmitting content meta data containing a user ID of the first user and the content ID to an integrated management server, and examining, by the integrated management server that manages content lists for individual users, the content meta data, adding the purchased content to an integrated content list of the first user, and displaying the integrated content list.

In accordance with another aspect of the present invention, a method for sharing digital content is provided. The method includes creating, by a first user, a purchase request message containing a content ID of digital content to be purchased and a purchase type indication, and transmitting the purchase request message to a content providing server, transmitting, by the content providing server, requested content and at least one key to the first user, storing, by the first user, the received content and key, transmitting, by the content providing server, content meta data containing a user ID of the first user, the content ID and the purchase type indication to an integrated management server, and adding, by the integrated management server, the purchased content and the purchase type indication to an integrated content list of the first user and displaying the integrated content list.

In accordance with still another aspect of the present invention, a system for sharing digital content is provided. The system includes a first user terminal for transmitting a purchase request message containing a content ID of digital content to be purchased and a purchase type indication, and for storing received content and key data, a content providing server for transmitting, in response to the purchase request message, requested content and key data corresponding to the content ID to the first user terminal, and for transmitting content meta data containing identification information of the first user terminal, the content ID and the purchase type indication, and an integrated management server for managing integrated content lists for individual user terminals, and for adding, upon reception of the content meta data, the purchased content to an integrated content list of the first user terminal.

In accordance with yet another aspect of the present invention, a system for sharing digital content is provided. The system includes a purchaser terminal for transmitting a purchase request message containing a content ID of digital content to be purchased and a purchase type indication, and for transmitting, when a rental request message containing a content ID is received, an acceptance message containing key data for the content ID, a Social Network Services (SNS) server for forwarding, when an update message is received from the purchaser terminal, the update message to other user terminals, a content providing server for transmitting, in response to the purchase request message from the purchaser terminal, requested content and key data corresponding to the content ID to the purchaser terminal, and for transmitting, in response to a rental request message containing key data, requested content matching the key data, a renter terminal for transmitting, in response to the update message from the SNS server, a rental request message containing a content ID to the purchaser terminal, for transmitting the key data contained in the acceptance message to the content providing server, and for receiving rented content, and an integrated management server for receiving content meta data as to purchase or rental from the content providing server, for updating integrated content lists of the purchaser terminal and the renter terminal according to the received content meta data, and for transmitting an update message containing link information to the integrated content lists and update information to the SNS server.

In a feature of the present invention, personalized integrated content lists are provided to individual users and information on the content lists is shared among the users through social network services. In addition to sharing of content list information, a method is provided that enables content purchased or directly created by a user to be lent to other users. The method of present invention has the following advantages over existing methods. In existing methods, the user may only purchase content from a content provider. That is, the user may not rent the purchased content to another user, and may only recommend the content. In the present invention, a personalized integrated content list is provided to a user and the content list may be shared among different users. As the integrated content list may act as a personalized homepage (like “minihompy in Cyworld”), it may generate various value-added services. As the method of the present invention is combined with social network services, it is possible to exchange and share rich information, which may lead to advertisement of digital content and promote activation of digital content markets. It is also possible to promote usage of digital content through rental and resale of digital content.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a system for sharing digital content according to an exemplary embodiment of the present invention;

FIG. 2 is a sequence diagram illustrating a procedure for purchasing digital content in the system of FIG. 1 according to an exemplary embodiment of the present invention;

FIG. 3 is a collaboration diagram for a procedure of uploading user content such as an album or diary that is directly created by the user to an integrated management server according to an exemplary embodiment of the present invention;

FIG. 4 is a sequence diagram illustrating a procedure for updating an integrated content list of a user on the basis of a configuration in FIG. 3 according to an exemplary embodiment of the present invention;

FIG. 5 is a collaboration diagram for a procedure of renting of an e-book from a first user to a second user according to an exemplary embodiment of the present invention;

FIG. 6 is a sequence diagram illustrating a procedure for renting or reselling content on the basis of a configuration in FIG. 5 according to an exemplary embodiment of the present invention;

FIG. 7 depicts a structure of an integrated content list registered by the procedure of FIG. 2 and a structure of an update message that is sent by a Social Network Services (SNS) server to other users according to content list update according to an exemplary embodiment of the present invention; and

FIG. 8 depicts changes in two integrated content lists of a user terminal renting out an e-book and a user terminal renting the e-book according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention relate to a system for selling Digital Rights Management (DRM)-protected digital content and to a method that enables rental and resale of purchased digital content between users. A user may manage not only purchased digital content but also digital content directly created by the user in an integrated manner. The user may update the digital content being managed. The user may notify other users of the managed digital content through social network services, and may share, according to a request from a notified user, the integrated digital content with the requesting user or rent out (or sell) the same to the requesting user.

In an exemplary embodiment, a user may provide information on integrated digital content of the user to other users, users may easily access each other's bookshelves through social network services and share purchased or directly created digital content. A description is given of an exemplary procedure for renting e-books using social network services, an exemplary procedure for renting e-books using DRM techniques, an exemplary procedure for making and accepting rental requests using social network services, and an exemplary configuration of an integrated management server.

In an exemplary embodiment, digital content may be digital media items such as e-books, movies, songs, and the like. In the following description, a digital media item is assumed to be an e-book. However, it is to be understood that this is merely for sake of convenience in description and not intended to be limiting. An integrated content list is a list or catalog of items of digital content purchased or rented by a user. The integrated content list may be used to manage some or all digital content owned by the user, and may be open to other users. In the description, a “user” may refer to a user terminal according to context. A first user (or user A) may refer to a user terminal that is used to purchase digital content and rent or sell the purchased digital content to another user. A second user (or user B) may refer to a user other than the first user and may refer to a user terminal that is used to rent digital content from the first user. The meaning of “resale” may include the meaning of “rental”.

An exemplary system of the present invention may include a content providing server, an integrated management server, a Social Network Services (SNS) server, a first user, and a second user. The first user and the second user may each be a user terminal capable of handling e-books such as a smartphone, an MP3 receiver, a tablet computer, a laptop computer or an e-book reader, and may access the Internet through a wireless local area network or a mobile communication network. In the following description, the first user may purchase an e-book, and the second user may obtain information on e-books of the first user and rent or buy an e-book purchased by the first user. The integrated management server manages shelves (i.e., integrated content lists) of registered users, stores meta information and layout information of registered e-books, and may also store e-books directly created by users. The integrated management server sends information on the bookshelf of the first user (addition or rental of an e-book) to friends (namely, second users) with the help of the SNS server. The content providing server sells e-books to users and applies a DRM technique to an e-book to be sold for copyright protection. The content providing server provides a set of secret keys together with a sold e-book to the first user so that the first user may rent the purchased e-book to friends.

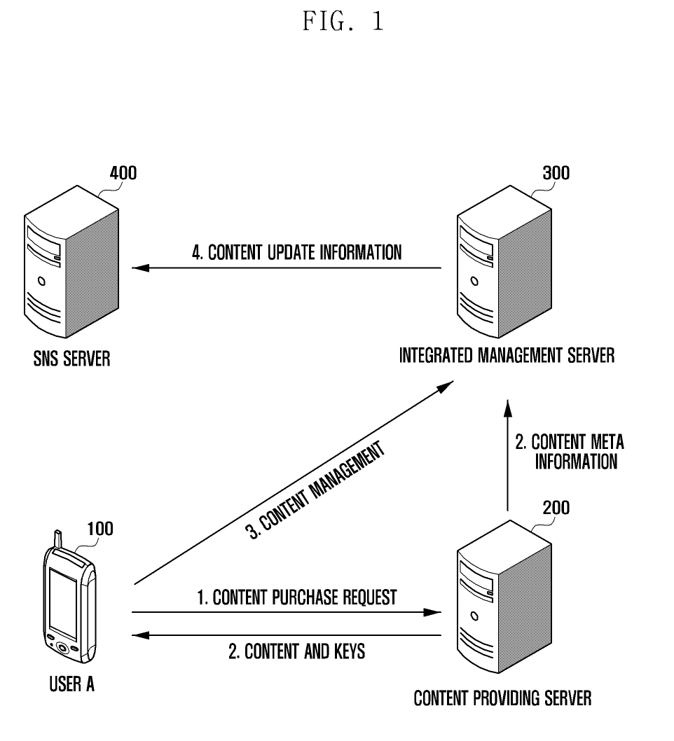

FIG. 1 illustrates a system for sharing digital content according to an exemplary embodiment of the present invention.

Referring to FIG. 1, to purchase an e-book, a first user 100 connects to a content providing server 200, examines lists of e-books and related descriptions, and sends a purchase request for a desired e-book to the content providing server 200. In an exemplary implementation, an e-book may be purchased for personal use only as in existing schemes or may be purchased for personal use and for rental or resale. In the following description, an e-book may be purchased for personal use and for rental or resale. In response to the purchase request, the content providing server 200 performs a billing procedure and transmits the requested e-book and a set of secret keys for rental or resale to the first user 100. The number of secret keys for rental or resale may be varied according to policies of the content providing server 200. Also, the content providing server 200 transmits meta information regarding the e-book purchased by the first user 100 to an integrated management server 300.

The integrated management server 300 adds the purchased e-book to the integrated content list of the first user 100 and marks the e-book as rentable or resalable. The first user 100 may update the integrated content list in terms of layout, rental policy and accessibility. To achieve this, the first user 100 connects to the integrated management server 300 and sends a message for management of the integrated content list to the integrated management server 300. The integrated management server 300 examines the management message and changes the layout, content rental policy, or accessibility of the integrated content list of the first user 100. When a change is made to the integrated content list of the first user 100, the integrated management server 300 notifies an SNS server 400 of such change using SNS account information. That is, the integrated management server 300 creates an update message and transmits the update message to the SNS server 400, which forwards the update message to other users associated with the first user 100.

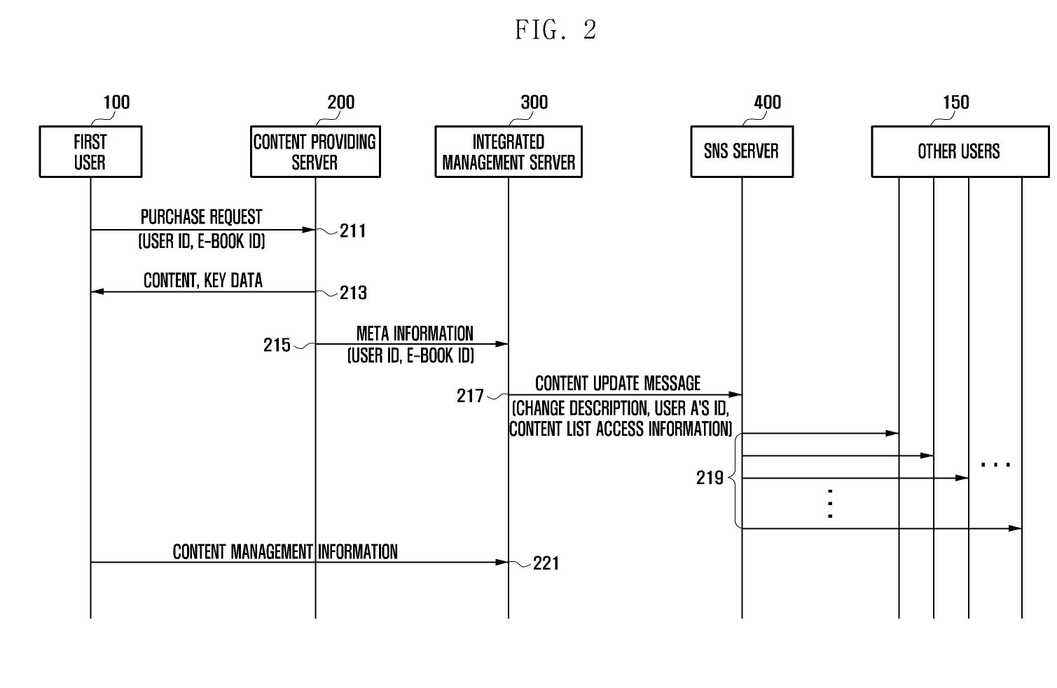

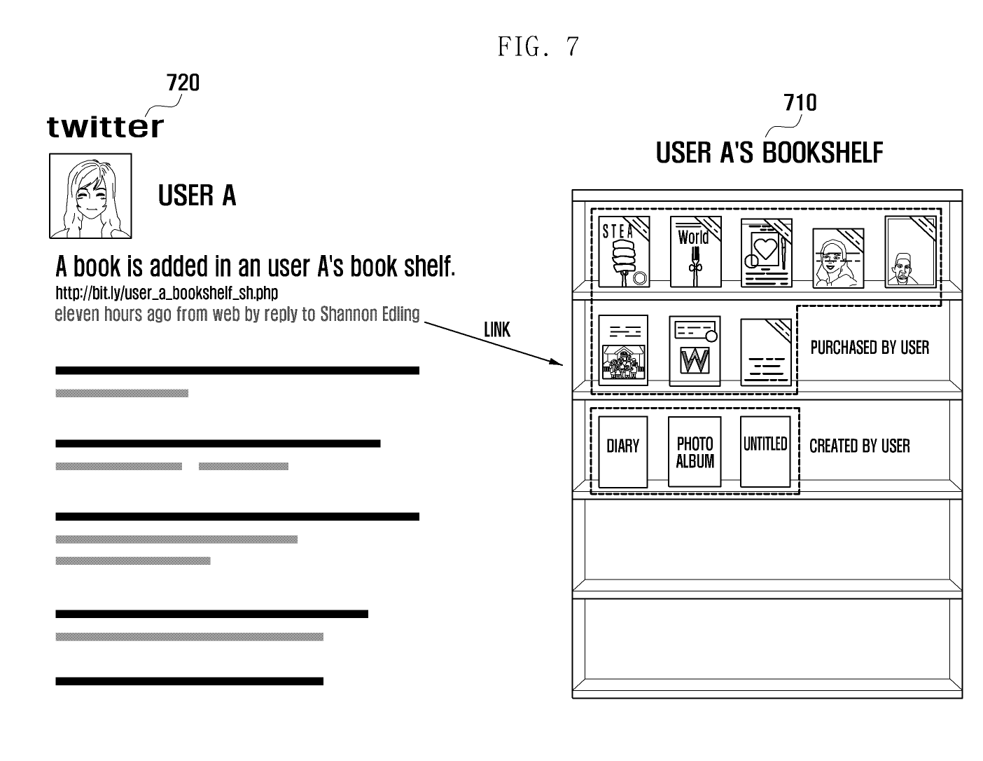

FIG. 2 is a sequence diagram illustrating a procedure for purchasing digital content in the system of FIG. 1 according to an exemplary embodiment of the present invention. FIG. 7 depicts a structure of an integrated content list registered by the procedure of FIG. 2 and a structure of an update message that is sent by an SNS server to other users according to content list update according to an exemplary embodiment of the present invention.

Referring to FIG. 2, the first user 100 connects to the content providing server 200 and finds an e-book to be purchased. Here, the content providing server 200 may provide information on e-books and sales information. The sales information may include personal use indication or rentability/resalability indication for individual e-books. In the following description, the first user 100 is assumed to purchase a rentable or resalable e-book. The first user 100 sends a purchase request message to the content providing server 200 at step 211. The purchase request message may contain a user ID, an e-book ID, rental/resale information (the number of rentals or resales), and billing information (credit card, terminal identification information). The price of an e-book may vary according to the rental/resale information.

The content providing server 200 examines the purchase request message, finds the requested e-book, generates key data for rental/resale of the e-book, and transmits the e-book and key data to the first user 100 at step 213. Here, the key data may include multiple secret keys, and may be divided into key data for rental and key data for resale. The first user 100 stores the received e-book and key data in an internal memory. In addition, the content providing server 200 transmits meta information regarding the purchased e-book to the integrated management server 300 at step 215. Here, the meta information regarding the e-book may contain identification information of the first user 100, information regarding the purchased e-book including a book name, and rental/resale information. Upon reception of the e-book meta information, the integrated management server 300 identifies the bookshelf (integrated content list) of the first user 100, adds the purchased e-book to the bookshelf, and marks the e-book as rentable or resalable. Here, the bookshelf (integrated content list) of the first user 100 may have a structure indicted by reference symbol 710 of FIG. 7.

After updating the bookshelf information of the first user 100, the integrated management server 300 transmits a content update message to the SNS server 400 at step 217. The content update message may contain the title of the added e-book and link information of the bookshelf of the first user 100 managed by the integrated management server 300. The content update message may have a structure indicted by reference symbol 720 of FIG. 7. The SNS server 400 forwards the content update message to other users 150 registered as friends of the first user 100 at step 219.

The first user 100 may change the integrated content list registered in the integrated management server 300. To achieve this, the first user 100 transmits content management information to the integrated management server 300 at step 221. The content management information may contain a user ID, an e-book ID (or content ID) and a layout location that are to be changed. The integrated management server 300 makes a modification to the integrated content list of the first user 100 (such as layout location).

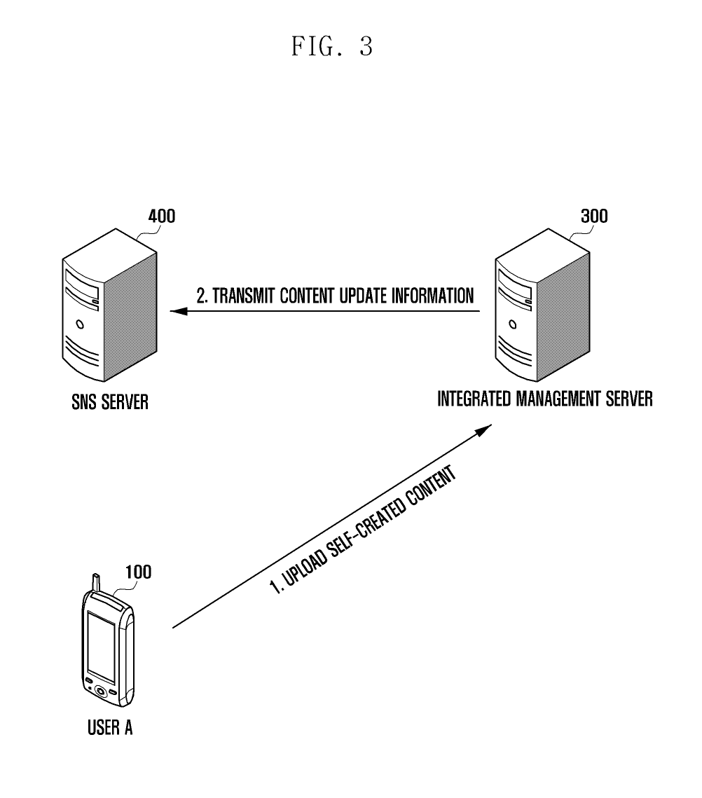

FIG. 3 is a collaboration diagram for a procedure of uploading user content such as an album or diary that is directly created by the user to an integrated management server according to an exemplary embodiment of the present invention.

Referring to FIG. 3, the first user 100 transmits self created content together with desired policies to the integrated management server 300. Here, the upload information may contain information on the created content and information on the location at which the created content is displayed. The created content may be a diary, an album, a moving image, and the like. The integrated management server 300 registers the upload information from the first user 100 in the integrated content list, and creates an update message for the integrated content list and transmits the update message to the SNS server 400. The SNS server 400 forwards the update message to other users 150 (second users) registered as friends of the first user 100.

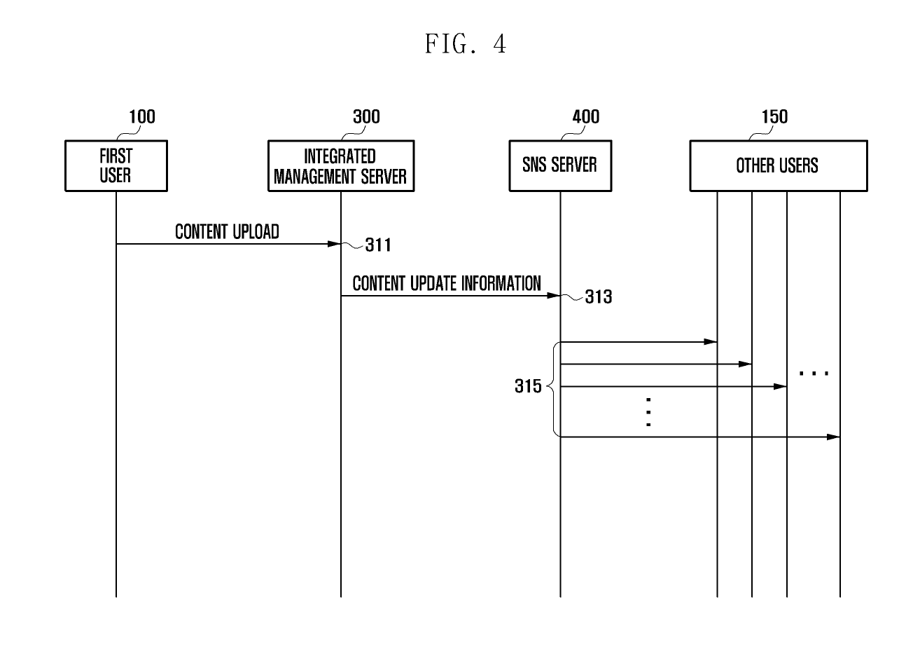

FIG. 4 is a sequence diagram illustrating a procedure for updating an integrated content list of a user on the basis of the configuration in FIG. 3 according to an exemplary embodiment of the present invention.

Referring to FIG. 4, the first user 100 may upload self-created content (not a purchased e-book) to the integrated content list. The self-created content may be an album containing photographs, a diary, a moving image, and the like. To achieve this, the first user 100 transmits an upload message containing self-created content and setting information specifying the display location of the integrated content list to the integrated management server 300 at step 311. In addition, at step 311, to update information on e-books on the integrated content list (for example, restrictions on purchase or sale, or location change), the first user 100 may create an upload message for updating e-book information and transmit the upload message.

The integrated management server 300 receives the upload message, examines the upload message, updates the integrated content list of the first user 100, creates a content update message for updated content, and transmits the content update message to the SNS server 400 at step 313. The SNS server 400 forwards the content update message to other users 150 registered as friends of the first user 100 at step 315.

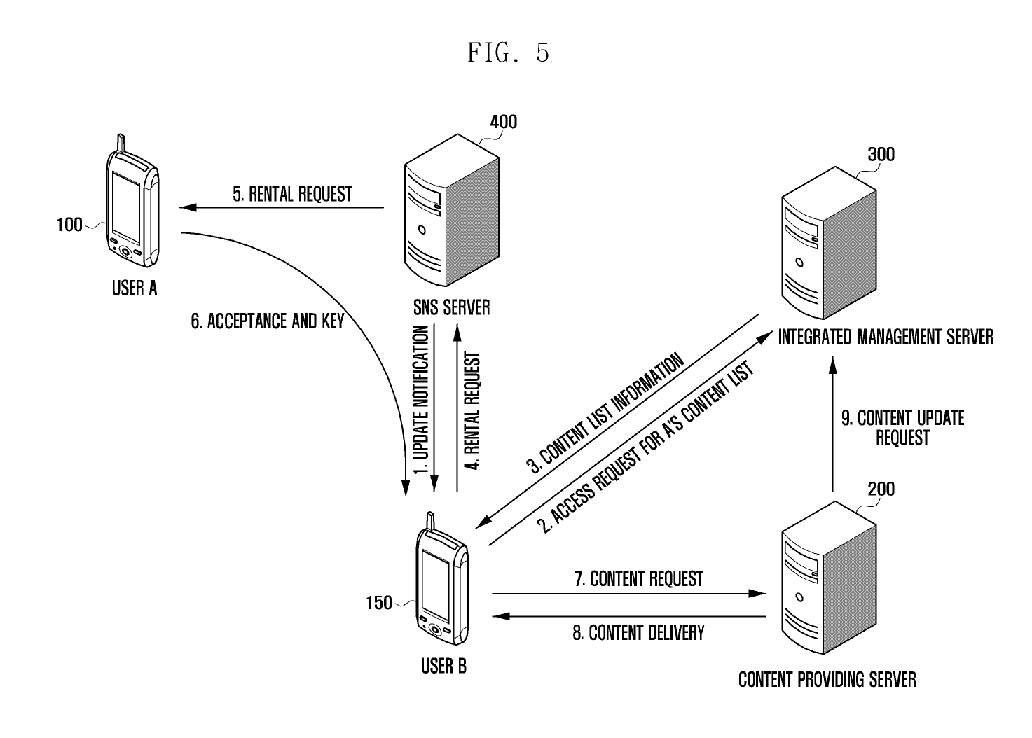

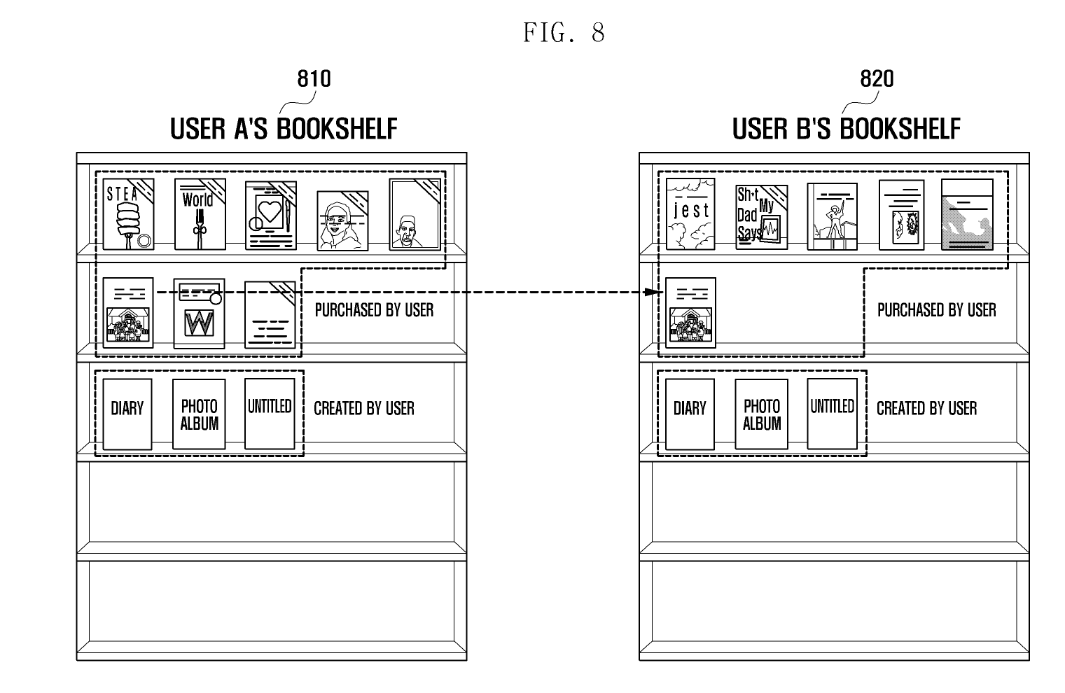

FIG. 5 is a collaboration diagram for a procedure of renting of an e-book from a first user to a second user according to an exemplary embodiment of the present invention. FIG. 8 depicts changes in two integrated content lists of a user terminal renting out an e-book and a user terminal renting the e-book according to an exemplary embodiment of the present invention

Referring to FIG. 5, the first user 100 (i.e., User A) owns one or more e-books that are rentable or resalable and the second user 150 (i.e., User B) rents or buys an e-book from the first user 100. As described before in connection with FIGS. 1 to 4, the first user 100 updates the bookshelf by, for example, purchasing an e-book or rearranging the bookshelf. Here, the purchased e-book may be rentable or resalable. Information regarding the updated bookshelf (integrated content list) is transmitted through the integrated management server 300 and the SNS server 400 to other users (including the second user 150) registered as friends of the first user 100.

When the bookshelf (integrated content list) of the first user 100 is updated, the SNS server 400 receives an update message (as indicted by reference symbol 720 of FIG. 7) from the integrated management server 300 and forwards the update message to the second user 150 registered as a friend of the first user 100. The update message contains link information corresponding to the integrated content list of the first user 100. When the second user 150 connects to the integrated management server 300 using the link information, the integrated management server 300 transmits information on the integrated content list of the first user 100 to the second user 150. The second user 150 may view the integrated content list (integrated bookshelf) of the first user 100 (as indicted by reference symbol 710 of FIG. 7). Here, e-books on the integrated content list may have a rentability/resalability indication for rental or resale.

After examining the integrated content list of the first user 100, the second user 150 may rent or buy an e-book from the first user 100. When a desired e-book is on the integrated content list (integrated bookshelf), the second user 150 sends a rental/resale request for the e-book to the first user 100 through the SNS server 400 (for example, “direct message” in Twitter). Upon reception of the rental/resale request from the second user 150, the first user 100 may accept or reject the request. When the first user 100 accepts the request, the first user 100 transmits a key for the requested e-book to the second user 150.

Upon reception of the key from the first user 100, the second user 150 sends a request message for the e-book to the content providing server 200. Here, the request message contains a first user ID and the key. The content providing server 200 determines validity of the request message from the second user 150 by determining whether the key belongs to the set of keys having been sent to the first user 100. When the request message from the second user 150 is valid, the content providing server 200 transmits the requested e-book with DRM protection to the second user 150. In the case of rental, the e-book may have an expiration date. The second user 150 may read the e-book before the expiration date and cannot read the e-book after the expiration date. When the second user 150 wishes to read the e-book after the expiration date, the second user 150 may buy or re-rent the e-book.

After the first user 100 rents or resells the e-book to the second user 150, the content providing server 200 transmits updated e-book information of the first user 100 and the second user 150 to the integrated management server 300. The integrated management server 300 updates the integrated content lists of the first user 100 and the second user 150, as indicted by reference symbols 810 and 820 of FIG. 8, on the basis of the updated e-book information. FIG. 8 illustrates layouts of the integrated bookshelves of the first user 100 and the second user 150 when the first user 100 rents an e-book to the second user 150. As shown in FIG. 8, an e-book rented from the first user 100 is added to the bookshelf 820 of the second user 150.

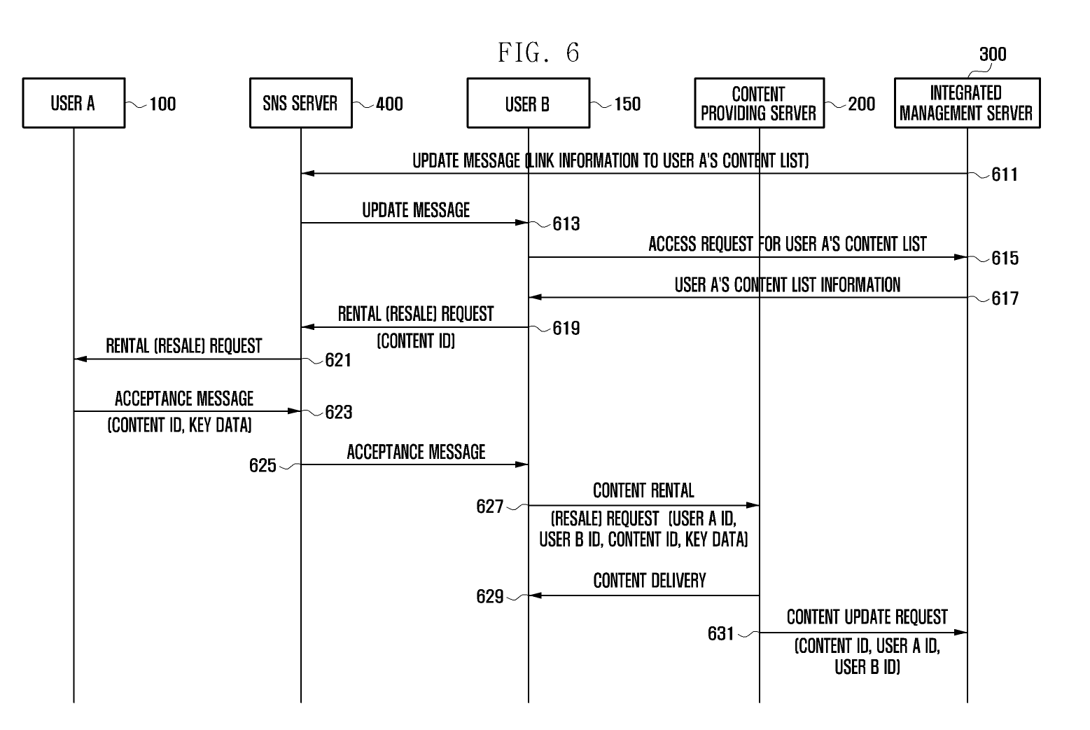

FIG. 6 is a sequence diagram illustrating a procedure for renting or reselling content on the basis of the configuration in FIG. 5 according to an exemplary embodiment of the present invention.

Referring to FIG. 6, when a change arises in relation to an e-book (content) of the first user 100 (i.e., User A), the integrated management server 300 receives corresponding update information from the content providing server 200 or the first user 100, creates an update message, and transmits the update message for the first user 100 to the SNS server 400 at step 611. Here, the update message contains link information corresponding to the integrated bookshelf (integrated content list) of the first user 100 and an update description. The SNS server 400 forwards the update message to the second user 150 (i.e., User B) at step 613.

The second user 150 may be aware of the updated information of the first user 100, and may access the integrated bookshelf of the first user 100 using the link information contained in the update message as desired. More specifically, the second user 150 sends an access request containing the link information to the integrated management server 300 at step 615. The integrated management server 300 examines the link information and provides information on the integrated bookshelf of the first user 100 to the second user 150 at step 617. The integrated bookshelf information may include a personal use indication or a rentability/resalability indication for individual e-books.

To rent (or purchase) an e-book from the first user 100, the second user 150 selects an e-book to rent (or purchase), creates a rental (or resale) request message containing an e-book ID, a second user ID, a rental (or resale) indication and billing information (credit card number and telephone number), and transmits the rental request message to the SNS server 400 at step 619. The SNS server 400 forwards the rental request message from the second user 150 to the first user 100 at step 621. Here, as the rental request message carries confidential information, it is preferable to encrypt the rental request message.

Upon reception of the rental request message, the first user 100 may accept or reject the rental (or resale) request. When the first user 100 accepts the rental request, the first user 100 creates an acceptance message containing a requested content ID and key (a key for rental may differ from a key for resale), and transmits the acceptance message to the SNS server 400 at step 623. The SNS server 400 forwards the acceptance message of the first user 100 to the second user 150 at step 625.

Upon reception of the acceptance message, the second user 150 creates a rental request message containing the received key, the first user ID, the second user ID and the e-book ID, and transmits the rental request message to the content providing server 200 at step 627. The content providing server 200 determines whether the received key belongs to the set of keys having been sent to the first user 100, and transmits, when the received key belongs to the set of keys having been sent, the requested e-book to the second user 150 at step 629. The content providing server 200 transmits update information for the e-book to the integrated management server 300 at step 631. The update information may contain the e-book ID, the first user ID, the second user ID and a change description. Thereafter, the second user 150 stores the received e-book and may display the e-book on a display window if necessary. The integrated management server 300 updates integrated bookshelf information of the first user 100 and the second user 150 according to the update information received from the content providing server 200. In the case of rental, the rental count of the e-book on the integrated bookshelf of the first user 100 may be decremented by one, and the rented e-book may be displayed in the integrated bookshelf of the second user 150 as indicated by reference symbol 820 of FIG. 8.

As described hereinabove, the system for sharing digital content of the present invention provides personalized integrated content lists to individual users so that the users may share information regarding the integrated content lists through social network services. In addition to sharing of information, content purchased or created by a user may be rented or resold to another user.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for sharing digital content, the method comprising:
creating, by a first user, a purchase request message containing a content ID of digital content to be purchased, and transmitting the purchase request message to a content providing server;
transmitting, by the content providing server, requested content to the first user, and transmitting content meta data containing a user ID of the first user and the content ID to an integrated management server; and
examining, by the integrated management server that manages content lists for individual users, the content meta data, adding the purchased content to an integrated content list of the first user, and displaying the integrated content list.

2. The method of claim 1, further comprising:
creating, by the integrated management server after content addition, an update message containing content update information and link information corresponding to the integrated content list of the first user, and transmitting the update message to a Social Network Services (SNS) server;
forwarding, by the SNS server, the update message to a second user; and
transmitting, by the integrated management server, when the second user connects to the integrated management server using the link information contained in the update message, information on the integrated content list to the second user.

3. The method of claim 2, wherein the first user and the second user are users registered in the SNS server.

4. The method of claim 3, further comprising:
changing, by the integrated management server in response to a layout change request from the first user, content arrangement in the integrated content list of the first user; and
adding, by the integrated management server in response to a content upload request from the first user, uploaded content to the integrated content list of the first user.

5. A method for sharing digital content, the method comprising:
creating, by a first user, a purchase request message containing a content ID of digital content to be purchased and a purchase type indication, and transmitting the purchase request message to a content providing server;
transmitting, by the content providing server, requested content and at least one key to the first user;
storing, by the first user, the received content and key;
transmitting, by the content providing server, content meta data containing a user ID of the first user, the content ID and the purchase type indication to an integrated management server; and
adding, by the integrated management server, the purchased content and the purchase type indication to an integrated content list of the first user and displaying the integrated content list.

6. The method of claim 5, further comprising:
creating, by the integrated management server after content addition, an update message containing content update information and link information corresponding to the integrated content list of the first user, and transmitting the update message to a Social Network Services (SNS) server;
forwarding, by the SNS server, the update message to a second user; and
transmitting, by the integrated management server when the second user connects to the integrated management server using the link information contained in the update message, information on the integrated content list to the second user.

7. The method of claim 6, further comprising:
transmitting, by the second user, a resale request message containing a content ID to the first user;
transmitting, by the first user, an acceptance message containing a key for resale to the second user;
transmitting, by the second user, a resale request message containing the key to the content providing server;
transmitting, by the content providing server, resale-requested content to the second user, and transmitting meta information of the resold content to the integrated management server; and
updating, by the integrated management server, integrated content lists of the first user and the second user according to the received meta information.

8. The method of claim 7, wherein resale activities comprise rental activities.

9. The method of claim 8, further comprising:
transmitting, by the second user when an update message as to the first user is received from the SNS server, an access request for the integrated content list of the first user to the integrated management server utilizing link information contained in the update message;
transmitting, by the integrated management server, the integrated content list of the first user to the second user; and
selecting, by the second user, content to be rented in the integrated content list of the first user.

10. The method of claim 9, wherein the first user and the second user are users registered in the SNS server.

11. The method of claim 10, further comprising changing, by the integrated management server in response to a layout change request from the first user, content arrangement in the integrated content list of the first user.

12. The method of claim 11, further comprising adding, by the integrated management server in response to a content upload request from the first user, uploaded content to the integrated content list of the first user.

13. The method of claim 8, further comprising decreasing, by the integrated management server, a counter corresponding to the rented content by one.

14. The method of claim 7, wherein the transmitting, by the second user, of the resale request message containing a content ID to the first user comprises:
transmitting, by the second user, the resale request message to the SNS server; and
transmitting, by the SNS server, the resale request message to the first user.

15. The method of claim 14, wherein the transmitting by the SNS server comprises transmitting encrypted information.

16. A system for sharing digital content, the system comprising:
a first user terminal for transmitting a purchase request message containing a content ID of digital content to be purchased and a purchase type indication, and for storing received content and key data;
a content providing server for transmitting, in response to the purchase request message, requested content and key data corresponding to the content ID to the first user terminal, and for transmitting content meta data containing identification information of the first user terminal, the content ID and the purchase type indication; and
an integrated management server for managing integrated content lists for individual user terminals, and for adding, upon reception of the content meta data, the purchased content to an integrated content list of the first user terminal.

17. The system of claim 16, further comprising a Social Network Services (SNS) server, wherein, when the integrated content list of the first user is updated, the integrated management server creates an update message containing content update information and link information corresponding to the integrated content list of the first user terminal and transmits the update message to the SNS server, the SNS server forwards the update message to a second user terminal, and the integrated management server transmits, when the second user terminal connects to the integrated management server using the link information contained in the update message, information on the integrated content list of the first user terminal to the second user terminal.

18. The system of claim 17, wherein the first user terminal transmits, when a resale request message containing a content ID is received from the second user terminal, an acceptance message containing key data for resale to the second user terminal, the content providing server transmits, when a resale request message containing the key data is received from the second user terminal, resale-requested content to the second user terminal and transmits meta information regarding the resold content to the integrated management server, and the integrated management server updates integrated content lists of the first user terminal and the second user terminal according to the received meta information.

19. The system of claim 18, wherein the resale activities comprise rental activities.

20. A system for sharing digital content, the system comprising:
a purchaser terminal for transmitting a purchase request message containing a content ID of digital content to be purchased and a purchase type indication, and for transmitting, when a rental request message containing a content ID is received, an acceptance message containing key data for the content ID;
a Social Network Services (SNS) server for forwarding, when an update message is received from the purchaser terminal, the update message to other user terminals;
a content providing server for transmitting, in response to the purchase request message from the purchaser terminal, requested content and key data corresponding to the content ID to the purchaser terminal, and for transmitting, in response to a rental request message containing key data, requested content matching the key data;
a renter terminal for transmitting, in response to the update message from the SNS server, a rental request message containing a content ID to the purchaser terminal, for transmitting the key data contained in the acceptance message to the content providing server and for receiving rented content; and
an integrated management server for receiving content meta data as to purchase or rental from the content providing server, for updating integrated content lists of the purchaser terminal and the renter terminal according to the received content meta data, and for transmitting an update message containing link information to the integrated content lists and update information to the SNS server.
